(19) United States
(12) Patent Application Publication
(10) Pub. No.: US 2002/0083254 A1
(43) Pub. Date: Jun. 27, 2002

(54) System and method of implementing interrupts in a computer processing system having a communication fabric comprising a plurality of point-to-point links

(76) Inventors: Mark D. Hummel, Franklin, MA (US); Derrick R. Meyer, Austin, TX (US)

Correspondence Address: Diana M. Sangalli, P.O. Box 692289, Houston, TX, 77269, US

(21) Appl. No.: 09/746,970

(22) Filed: Dec. 22, 2000

(51) Int. Cl. G06F 13/24

(52) U.S. Cl. 710/261

(57) ABSTRACT

A method for implementing interrupt requests in a computing system comprising a plurality of processing devices interconnected by a plurality of point-to-point links is provided. An interrupt request is broadcast on the point-to-point links to each of the plurality of processing devices. Each processing device is configured to decode the interrupt request to determine whether the processing device is a target of the interrupt request. Each processing device transmits a response to acknowledge receipt of the interrupt request, regardless of whether the processing device is a target of the interrupt request. If the interrupt request is an arbitrated request, each processing device also is configured to respond to the interrupt request with priority information. A processing device is then selected to service the arbitrated request based on the priority information. The processing device which services the interrupt request may transmit an end-of-interrupt message to indicate completion of servicing of the interrupt request.

### BACKGROUND OF THE INVENTION

1. Field of the Invention

The present invention relates generally to a computing system having a communication fabric comprising a plurality of point-to-point links interconnecting a plurality of devices. More particularly, the present invention relates to emulating interrupts on a communication fabric comprising a plurality of point-to-point links.

2. Background of the Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Many computer systems have been designed around a shared bus architecture that generally includes a processing subsystem having one or more processing devices and a system memory connected to a shared bus. Transactions between processing devices and accesses to memory occur on the shared bus, and all devices connected to the bus are aware of any transaction occurring on the bus. In addition to a processing subsystem, many computer systems typically include an input/output (I/O) subsystem coupled to the shared bus via an I/O bridge that manages information transfer between the I/O subsystem and the processing subsystem. Many I/O subsystems also generally follow a shared bus architecture, in which a plurality of I/O or peripheral devices are coupled to a shared I/O bus. Such I/O buses may be implemented, for example, as a Peripheral Component Interface (PCI) bus, a PCI-Registered (PCI-X) bus, or an Accelerated Graphics Port (AGP) bus. The I/O subsystem may include several branches of shared I/O buses interconnected via additional I/O bridges.

Such shared bus architectures have several advantages. For example, because the bus is shared, each of the devices coupled to the shared bus is aware of all transactions occurring on the bus. Thus, transaction ordering and memory coherency is easily managed. Further, arbitration among devices requesting access to the shared bus can be simply managed by a central arbiter coupled to the bus. For example, the central arbiter may implement an allocation algorithm to ensure that each device is fairly allocated bus bandwidth according to a predetermined priority scheme.

Shared buses, however, also have several disadvantages. For example, the multiple attach points of the devices coupled to the shared bus produce signal reflections at high signal frequencies which reduce signal integrity. As a result, signal frequencies on the bus are generally kept relatively low to maintain signal integrity at an acceptable level. The relatively low signal frequencies reduce signal bandwidth, limiting the performance of devices attached to the bus. Further, the multiple devices attached to the shared bus present a relatively large electrical capacitance to devices driving signals on the bus, thus limiting the speed of the bus. The speed of the bus also is limited by the length of the bus, the amount of branching on the bus, and the need to allow turnaround cycles on the bus. Accordingly, attaining very high bus speeds (e.g., 500 MHz and higher) is difficult in more complex shared bus systems.

Lack of scalability to larger numbers of devices is another disadvantage of shared bus systems. The available bandwidth of a shared bus is substantially fixed (and may decrease if adding additional devices causes a reduction in signal frequencies upon the bus). Once the bandwidth requirements of the devices attached to the bus (either directly or indirectly) exceeds the available bandwidth of the bus, devices will frequently be stalled when attempting access to the bus, and overall performance of the computer system including the shared bus will most likely be reduced.

The problems associated with the speed performance and scalability of a shared bus system may be addressed by implementing the bus as a bi-directional communication link comprising a plurality of independent sets of unidirectional point-to-point links. Each set of unidirectional links interconnects two devices, and each device may implement one or more sets of point-to-point links. The bi-directional communication link may be any suitable interconnect. For example, each device may be coupled to another device using dedicated lines. Alternatively, each device may connect to a fixed number of other devices via a corresponding number of point-to-point links. Transactions may be routed from a first device to a second device to which the first device is not directly connected via one or more intermediate devices.

In general, a device participates in transactions upon the bi-directional communication link. For example, the bi-directional communication link may be packet-based, and the device may be configured to receive and transmit packets as part of a transaction, which includes a series of packets. A “requester” or “source” device initiates a transaction directed to a “target” device by issuing a request packet. Each packet which is part of the transaction is communicated between two devices, with the receiving device of a particular packet being designated as the “destination” of that packet. When a packet ultimately reaches the target device, the target device accepts the information conveyed by the packet and processes the information internally. Alternatively, a device located on a communication path between the requester and target devices may relay the packet from the requester device to the target device.

In addition to the original request packet, the transaction may result in the issuance of ID other types of packets, such as responses, probes, and broadcasts, each of which is directed to a particular destination. For example, upon receipt of the original request packet, the target device may issue broadcast or probe packets to other devices in the processing system. These devices, in turn, may generate responses, which may be directed to either the target device or the requester device. If directed to the target device, the target device may respond by issuing a response back to the requester device.

Computing systems that implement a communication link having a plurality of independent point-to-point links present design challenges which differ from the challenges in shared bus systems. For example, shared bus systems regulate the initiation of transactions through bus arbitration. Accordingly, a fair arbitration algorithm allows each bus participant the opportunity to initiate transactions. The order of transactions on the bus may represent the order that transactions are performed (e.g., for coherency purposes). In point-to-point link systems, on the other hand, devices may initiate transactions concurrently and use the communication link to transmit the transactions to other devices. These transactions may have logical conflicts between them (e.g., coherency conflicts for transactions involving the same address) and may experience resource conflicts (e.g., buffer space may not be available in various devices), because no central mechanism for regulating the initiation of transactions is provided. Accordingly, it is more difficult to ensure that information continues to propagate among the devices smoothly and that deadlock situations (in which no transactions are completed due to conflicts between the transactions) are avoided.

Further the generation and handling of interrupt requests in a point-to-point link system also present design challenges. In a shared bus system, such as in a system following the x86 architecture, a separate interrupt bus (i.e., an Advanced Programmable Interrupt Control (APIC) bus) is provided for handling interrupt requests. Each of the processing devices in the host, or processing, subsystem are connected to the interrupt bus together with an interrupt controller. The interrupt controller processes and manages interrupt requests generated by the I/O devices and transmits the requests onto the interrupt bus to the appropriate processing device or devices. Thus, in the shared bus system, a separate interrupt bus and an interrupt controller are implemented in the computing system. Further, each of the I/O devices implements a separate interrupt line that connects the I/O device directly to the interrupt controller.

To address the disadvantages of shared bus systems discussed above, it would be desirable to provide a computing system in which the various devices are interconnected by independent point-to-point links. Further, it would be desirable to provide a communication protocol for a point-to-point link system that ensures memory coherency and proper ordering of transactions is properly managed and maintained. Still further, it would be desirable to provide an interrupt handling scheme that does not employ an additional interrupt bus, an interrupt controller, or separate links from each I/O device to an interrupt controller.

The present invention may be directed to one or more of the problems set forth above.

### SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In accordance with one aspect of the present invention, there is provided a method of implementing interrupt requests in a computing system comprising a plurality of devices interconnected by a plurality of point-to-point links. The plurality of devices includes a plurality of processing devices. The method comprises the acts of transmitting an interrupt request packet to each of the plurality of processing devices and determining at each of the processing devices if the processing device comprises a target of the interrupt request packet.

In accordance with another aspect of the present invention, there is provided a method of implementing interrupt requests in a computing system comprising a first device and a plurality of processing devices interconnected by a plurality of point-to-point links. The method comprises generating, at the first device, a first communication comprising an interrupt request. The first communication is broadcast on the plurality of point-to-point links to the plurality of processing devices. Each of the processing devices decodes the first communication and determines, based on the decoding, whether to service the interrupt request.

In accordance with still another aspect of the present invention, there is provided a computing system comprising a communication link comprising a plurality of point-to-point links and a plurality of devices configured to communicate on the communication link. The plurality of devices comprises a first device and a plurality of processing devices. The first device is configured to broadcast a first interrupt request to the plurality of processing devices. Each of the plurality of processing devices is configured to determine whether to deliver the first interrupt request to its local processor for servicing. Each of the plurality of processing devices also is configured to transmit a response to the first device to acknowledge the first interrupt request, regardless of whether the first interrupt request is serviced by the processing device.

### BRIEF DESCRIPTION OF THE DRAWINGS

The foregoing and other advantages of the invention will become apparent upon reading the following detailed description and upon reference to the drawings in which:

FIG. 1 is a block diagram illustrating a computing system which includes a processing subsystem and an input/output (I/O) subsystem interconnected by a bridge device;

FIG. 2 is a block diagram illustrating an exemplary embodiment of the computing system of FIG. 1 which implements a communication link as a plurality of point-to-point links, in accordance with the invention;

FIG. 3 illustrates exemplary details of a point-to-point communication link of FIG. 2, in accordance with the invention;

FIG. 4 illustrates an exemplary format of a coherent information packet used in the computing system of FIG. 2;

FIG. 5 illustrates an exemplary format of a coherent request packet used in the computing system of FIG. 2;

FIG. 6 illustrates an exemplary format of a coherent response packet used in the computing system of FIG. 2;

FIG. 7 illustrates an exemplary format of a coherent data packet used in the computing system of FIG. 2;

FIG. 8 is a table of exemplary command encodings for the coherent packets illustrated in FIGS. 4-6;

FIG. 9 illustrates an exemplary format of a non-coherent request packet used in the computing system of FIG. 2;

FIG. 10 illustrates an exemplary format of a non-coherent response packet used in the computing system of FIG. 2;

FIG. 11 is a table of exemplary command encodings for the non-coherent packets illustrated in FIGS. 9 and 10;

FIG. 12 is a table listing exemplary ordering rules for non-coherent packets traveling in the I/O subsystem of the computing system of FIG. 2, in accordance with the invention;

FIG. 13 is a table listing exemplary wait rules implemented by a bridge device in the computing system of FIG. 2 for issuing packets from the non-coherent fabric onto the coherent fabric, in accordance with the invention;

FIG. 14 is an exemplary format of a non-coherent sized write request packet for an interrupt request issued from an input/output (I/O) device in the computing system of FIG. 2, in accordance with the invention;

FIG. 15 is an exemplary format of a coherent broadcast interrupt packet sent to all processing devices in the processing subsystem of the computing system of FIG. 2, in accordance with the invention;

FIG. 16 is an exemplary diagrammatic illustration of the propagation of a fixed or non-vectored interrupt within the computing system of FIG. 2, in accordance with the invention;

FIG. 17 is an exemplary diagrammatic illustration of the propagation of an arbitrated interrupt within the computing system of FIG. 2, in accordance with the invention;

FIG. 18 is an exemplary format of a data packet accompanying a read response packet issued during the interrupt transaction illustrated in FIG. 17, in accordance with the invention; and

FIG. 19 is an exemplary diagrammatic illustration of the propagation of an end of interrupt message issued in the computing system of FIG. 2 after servicing of an interrupt, in accordance with the invention.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

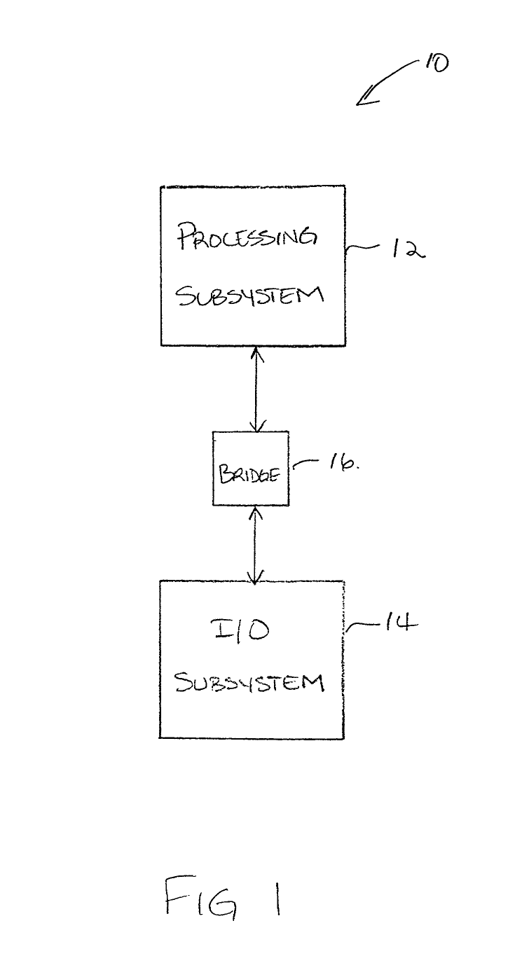

Turning now to the drawings, and with reference to FIG. 1, a computing system 10 is shown including a processing subsystem 12 and an input/output (I/O) subsystem 14. The processing subsystem 12 is connected to the I/O subsystem 14 via a bridge device 16 (e.g., a host bridge) which manages communications and interactions between the processing subsystem 12 and the I/O subsystem 14.

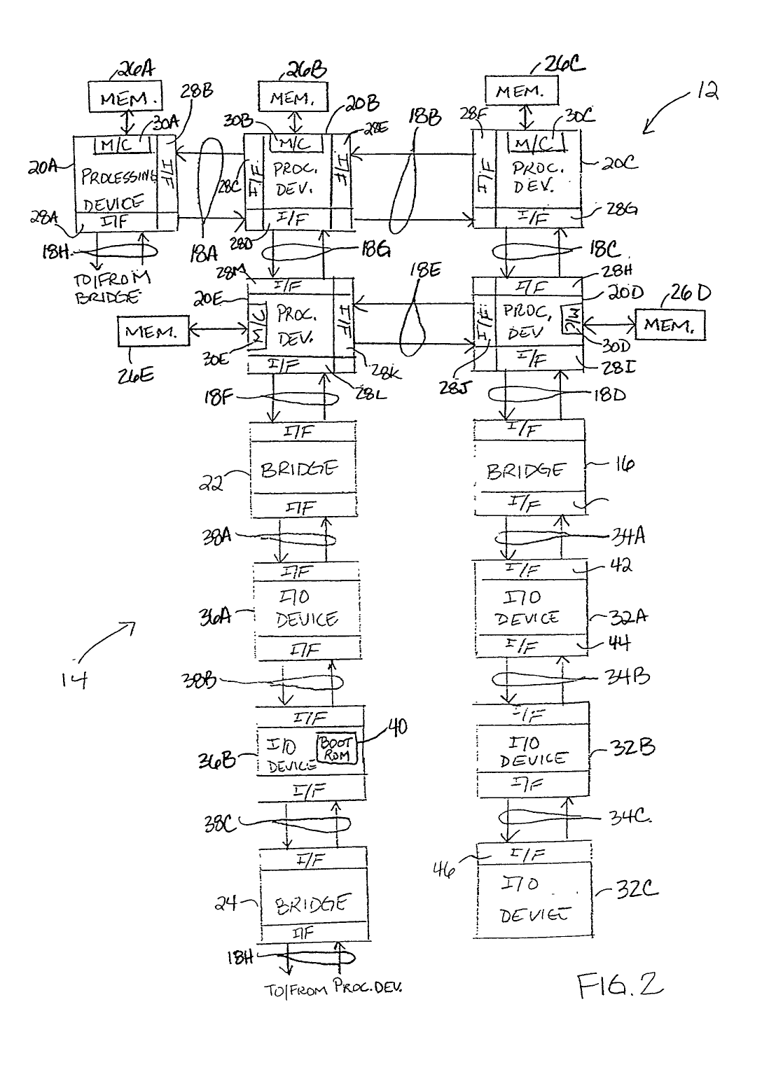

With reference to FIG. 2, the processing subsystem 12 is implemented as a distributed multiprocessing subsystem having a bi-directional communication link comprising a plurality of independent point-to-point bi-directional communication links 18A, 18B, 18C, 18D, 18E, 18F, 18G, and 18H interconnecting a plurality of processing devices 20A, 20B, 20C, 20D, and 20E and bridge devices 16, 22, and 24. The particular structure of the distributed processing subsystem 12 can vary based on the particular application for which the computing system 10 is intended. For example, as shown in FIG. 2, the processing devices 20B, 20C, 20D, and 20E are arranged in a ring structure, and the processing device 20A is a branch extending from the ring. Other types of structures are contemplated, such as interconnected rings, daisy chains, etc.

In the distributed processing subsystem 12 illustrated in FIG. 2, the system memory is mapped across a plurality of memories 26A, 26B, 26C, 26D, and 26E, each of which is associated with a particular processing device 20A-E. The memories 26A-E may include any suitable memory devices, such as one or more RAMBUS DRAMs, synchronous DRAMs, static RAM, etc. Each processing device 20A-E includes a processor configured to execute software code in accordance with a predefined instruction set (e.g., the x86 instruction set, the ALPHA instruction set, the POWERPC instruction set, etc.). Further, the processing devices 20A-E in the distributed processing subsystem 12 implement one or more bi-directional point-to-point links and, thus, include one or more interfaces (I/F) 28A-M to manage the transmission of communications to and from each bi-directional point-to-point link connected to that processing device. Still further, the processing devices 20A-E include memory controllers (M/C) 30A-E, respectively, for controlling accesses to the portion of memory associated with that processing device. Each processing device 20A-E also may include a cache memory (not shown) and packet processing logic (not shown) to receive, decode, process, format, route, etc. packets as appropriate. As would be realized by one of ordinary skill in the art, the particular configurations and constituent components of each processing device may vary depending on the application for which the computing system 10 is designed.

The I/O subsystem 14 illustrated in FIG. 2 has a structure which includes two daisy chains of I/O devices. The particular structure of the I/O subsystem 14, the number of daisy chains, and the number of I/O devices may vary in other embodiments. With reference to the embodiment in FIG. 2, the first daisy chain is a single-ended chain that includes the bridge device 16 and the I/O devices 32A, 32B, and 32C interconnected by bi-directional links 34A, 34B, and 34C. The bridge device 16 connects the I/O devices 32A, 32B, and 32C to the processing subsystem 12. The second daisy chain is a double-ended chain that includes the bridge device 22, the bridge device 24, and the I/O devices 36A and 36B interconnected by the bi-directional links 38A, 38B, and 38C. The bridge device 22 connects one end of the chain to the processing device 20E, and the bridge device 24 connects the other end of the chain to processing device 20A. Although the bridges 16, 22, and 24 are illustrated as separate devices, in other embodiments, the bridges may be integrated in one or more of the processing devices 20A-E in the processing subsystem 12.

Each I/O device 32A, 32B, 32C, 36A, and 36B generally may embody one or more logical I/O functions (e.g., modem, sound card, etc.). Further, one of the I/O devices may be designated as a default device, which may contain, among other items, the boot read-only memory (ROM) having the initialization code for initializing the computing system 10. In the embodiment illustrated in FIG. 2, the I/O device 36B is the default device which contains the boot ROM 40. Although only three physical I/O devices are interconnected in the first chain and two physical I/O device are interconnected in the second chain as shown in FIG. 2, it should be understood that more or fewer I/O devices may be interconnected in each daisy chain. For example, in one embodiment, up to thirty-one physical I/O devices or logical I/O functions may be connected in a chain. Further, the computing system 10 may support a single chain or more than two chains of I/O devices depending on the particular application for which the computing system 10 is designed.

Each I/O device in the I/O subsystem 14 may have interfaces to one or more bi-directional point-to-point links. For example, the I/O device 32A includes a first interface 42 to the bi-directional point-to-point link 34A and a second interface 44 to the bi-directional point-to-point link 34B. The I/O device 32C, on the other hand, is a single-link device having only a first interface 46 to the link 34C.

In some embodiments, a bridge device, such as a host bridge, may be placed at both ends of the daisy chain. To illustrate, the bridge device 22 is placed at one end of the second daisy chain in FIG. 2, while the bridge device 24 terminates the other end of the chain. In such embodiments, any appropriate technique may be implemented to designate which bridge device (e.g., bridge device 22) is the master bridge and which bridge device (e.g., bridge device 24) is the slave bridge. As shown in FIG. 2, the slave bridge device 24 is connected to the processing subsystem 12 via the processing device 20A. This type of configuration can be useful to ensure continued communication with the processing subsystem 12 in the event one of the bridges, I/O devices, or point-to-point links fails. In some embodiments, the I/O devices 36A and 36B in the double-ended daisy chain may be apportioned between the two bridge devices 22 and 24 to balance communication traffic even in the absence of a link failure.

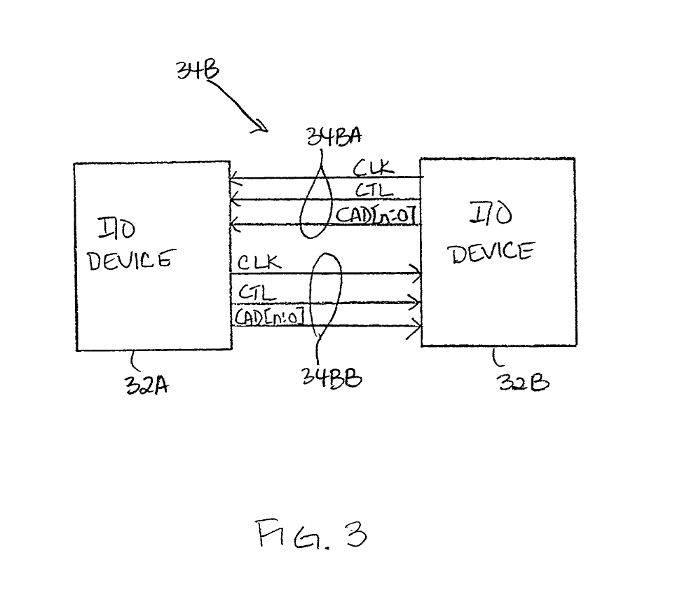

In an exemplary embodiment, each bi-directional point-to-point communication link 34A-C, 18A-H, and 36A-C is a packet-based link and may include two unidirectional sets of links or transmission media (e.g., wires). FIG. 3 illustrates an exemplary embodiment of the bi-directional communication link 34B which interconnects the I/O devices 32A and 32B. The other bi-directional point-to-point links in computing system 10 may be configured similarly. In FIG. 3, the bi-directional point-to-point communication link 34B includes a first set of three unidirectional transmission media 34BA directed from the I/O device 32B to the I/O device 32A, and a second set of three unidirectional transmission media 34BB directed from the I/O device 32A to the I/O device 32B. Both the first and second sets of transmission media 34BA and 34BB include separate transmission media for a clock (CLK) signal, a control (CTL) signal, and a command/address/data (CAD) signal.

In one embodiment, the CLK signal serves as a clock signal for the CTL and CAD signals. A separate CLK signal may be provided for each byte of the CAD signal. The CAD signal is used to convey control information and data. The CAD signal may be 2ⁿ bits wide, and thus may include 2ⁿ separate transmission media.

The CTL signal is asserted when the CAD signal conveys a bit time of control information, and is deasserted when the CAD signal conveys a bit time of data. The CTL and CAD signals may transmit different information on the rising and falling edges of the CLK signal. Accordingly, two bit times may be transmitted in each period of the CLK signal.

Because the devices in processing subsystem 12 and I/O subsystem 14 are connected to a bi-directional communication link that is implemented as a plurality of independent point-to-point links, an initialization procedure performed at system startup or reset integrates the independent point-to-point links and the devices connected thereto into a complete “fabric.” Thus, in the computing system 10 illustrated in FIG. 2, initialization results in establishing a first communication fabric for the processing subsystem 12 and a second communication fabric for the I/O subsystem 14. Communications on the fabric for the processing subsystem 12 are managed in a “coherent” fashion, such that the coherency of data stored in the memories 26A-E is preserved. In contrast, the fabric for the I/O subsystem 14 is a “non-coherent” fabric, because data stored in the I/O subsystem 14 is not cached.

A packet routed within the fabrics of the processing subsystem 12 and the I/O subsystem 14 may pass through one or more intermediate devices before reaching its destination. For example, a packet transmitted by the processing device 20B to the processing device 20D within the fabric of the processing subsystem 12 may be routed through either the processing device 20C or the processing device 20E. Because a packet may be transmitted to its destination by several different paths, packet routing tables in each processing device, which are defined during initialization of the processing subsystem fabric, provide optimized paths. Further, because the processing devices are not connected to a common bus and because a packet may take many different routes to reach its destination, transaction ordering and memory coherency issues are addressed. In an exemplary embodiment, communication protocols and packet processing logic in each processing device are configured as appropriate to maintain proper ordering of transactions and memory coherency within the processing subsystem 12.

Packets transmitted between the processing subsystem 12 and the I/O subsystem 14 pass through the bridge device 16, the bridge device 22, or the bridge device 24. Because the I/O devices in the I/O subsystem 14 are connected in daisy-chain structures, a transaction that occurs between two I/O devices is not apparent to other I/O devices which are not positioned in the chain between the I/O devices participating in the transaction. Thus, as in the processing subsystem 12, ordering of transactions cannot be agreed upon by the I/O devices in a chain. In an exemplary embodiment, to maintain control of ordering, direct peer-to-peer communications are not permitted, and all packets are routed through the bridge device 16, 22, or 24 at one end of the daisy chain. The bridge devices 16, 22, and 24 may include appropriate packet processing and translation logic to implement packet handling, routing, and ordering schemes to receive, translate, and direct packets to their destinations while maintaining proper ordering of transactions within I/O subsystem 14 and processing subsystem 12. Further, each I/O device may include appropriate packet processing logic to implement routing and ordering schemes, as desired.

In an exemplary embodiment, packets transmitted within the fabric of the I/O subsystem 14 travel in I/O streams, which are groupings of traffic that can be treated independently by the fabric. Because direct peer-to-peer communications are not implemented in the exemplary embodiment, all packets travel either to or from a bridge device 16, 22, or 24. Packets which are transmitted in a direction toward a bridge device are travelling “upstream.” Similarly, packets which are transmitted in a direction away from the bridge device are travelling “downstream.” Thus, for example, a packet transmitted by the I/O device 32C (i.e., the requesting device) to the I/O device 32A (i.e., the target device), travels upstream through I/O device 32B, through the I/O device 32A, to the bridge device 16, and back downstream to the I/O device 32A where it is accepted. This packet routing scheme thus indirectly supports peer-to-peer communication by having a requesting device issue a packet to the bridge device 16, and having the bridge device 16 manage packet interactions and generate a packet back downstream to the target device. To implement such a routing scheme, initialization of the I/O fabric includes configuring each I/O device such that it can identify its “upstream” and “downstream” directions.

To identify the source and destination of packets, each device in the processing subsystem 12 and the I/O subsystem 14 is assigned one or more unique identifiers during the initialization of the computing system. In an exemplary embodiment of the I/O subsystem 14, the unique identifier is referred to as a “unit ID,” and identifies the logical source or destination of each packet transmitted on the I/O communication link. For example, the unit ID identifies the source of a request packet or a response packet which is travelling in the upstream direction. Similarly, the unit ID identifies the source of a request packet which is travelling in the downstream direction. However, the unit ID in a downstream response packet identifies the destination of the packet. In I/O subsystems having more than one chain of I/O devices, each chain is also assigned an identifier such that the appropriate bridge device can accept and route packets from the processing subsystem 12 to an addressed I/O device connected to the bridge's chain. A particular I/O device may have multiple unit IDs if, for example, the device embodies multiple devices or functions which are logically separate. Accordingly, an I/O device on any chain may generate and accept packets associated with different unit IDs. In an exemplary embodiment, communication packets include a unit ID field having five bits. Thus, thirty-two unit IDs are available for assignment to the I/O devices or I/O functions connected in each daisy chain in the I/O subsystem 14. In some embodiments, the unit ID of “0” is assigned to the bridge device (e.g., bridge device 16). Accordingly, a chain may include up to thirty-one physical I/O devices or thirty-one logical I/O functions.

Each processing device 20A-E in the processing subsystem 12 also is assigned a unique identifier during the initialization of the computing system 10. In an exemplary embodiment of the processing subsystem 12, the unique identifier is referred to as a “source node ID” and identifies the particular processing device which initiated a transaction. The source node ID is carried in a three-bit field in packets which are transmitted on the processing subsystem's fabric, and thus a total of eight processing devices may be interconnected in the processing subsystem 12. Alternative embodiments may provide for the identification of more or fewer processing devices.

Each processing device 20A-E in the processing subsystem 12 also may have one or more units (e.g., a processor, a memory controller, a bridge, etc.) that may be the source of a particular transaction. Thus, unique identifiers also may be used to identify each unit within a particular processing device. In the exemplary embodiment, these unique identifiers are referred to as “source unit IDs” and are assigned to each unit in a processing device during initialization of the processing subsystem's fabric. The source unit ID is carried in a two-bit field in packets transmitted within the processing subsystem, and thus a total of four units may be embodied within a particular processing device.

The coherent packets used within processing subsystem 12 and the non-coherent packets used in I/O subsystem 14 may have different formats, and may include different data. As will be described in more detail below, the bridge devices 16, 22, and 24 translate packets moving from one subsystem to the other. For example, a non-coherent packet transmitted by the I/O device 32B and having a target within the processing device 20B passes through the I/O device 32A to the bridge device 16. The bridge device 16 translates the non-coherent packet to a corresponding coherent packet. The bridge device 16 may transmit the coherent packet to the processing device 20D, which then may forward the packet to either the processing device 20E or the processing device 20C. If the processing device 20D transmits the coherent packet to the processing device 20E, the processing device 20E may receive the packet, then forward the packet to the processing device 20B. On the other hand, if the processing device 20D transmits the coherent packet to the processing device 20C, the processing device 20C may receive the packet, then forward the packet to the processing device 20B.

Coherent Packets Within Processing Subsystem 12

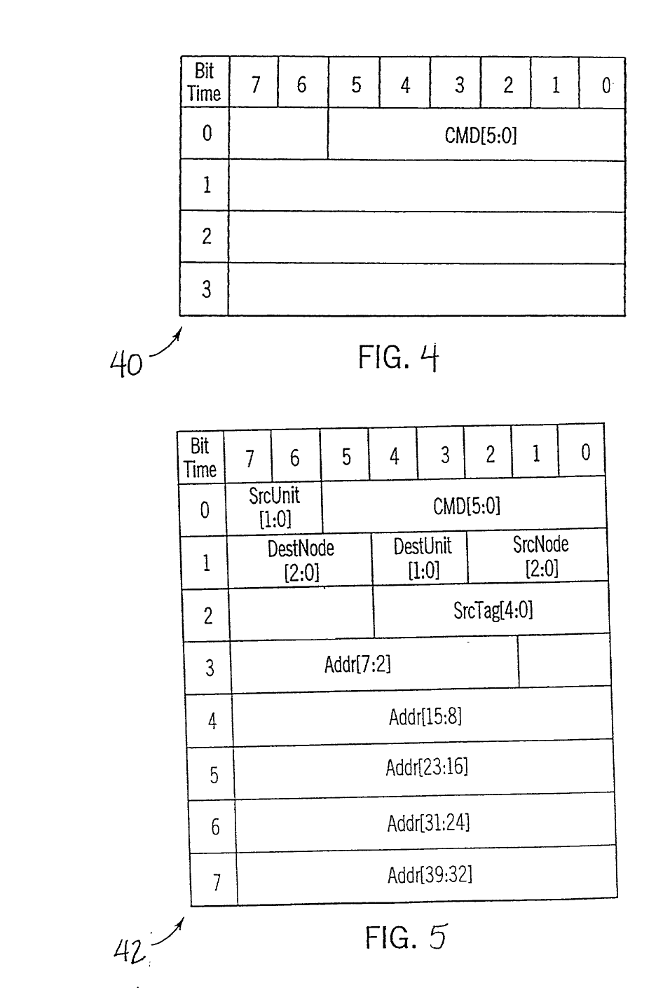

FIGS. 4-7 illustrate exemplary coherent packet formats which may be employed within processing subsystem 12. FIGS. 4-6 illustrate exemplary coherent information, request, and response packets, respectively, and FIG. 7 illustrates an exemplary coherent data packet. Information (info) packets carry information related to the general operation of the communication link, such as flow control information, error status, etc. Request and response packets carry control information regarding a transaction. Certain request and response packets may specify that a data packet follows. The data packet carries data associated with the transaction and the corresponding request or response packet. Other embodiments may employ different packet formats.

FIGS. 4-7 illustrate exemplary formats of the various types of coherent packets for an eight-bit communication link that may be used in one embodiment of the processing subsystem 12. The packet formats illustrate the contents of eight-bit bytes transmitted in parallel during consecutive “bit times.” A “bit time” is the amount of time used to transmit each data unit of a packet (e.g., a byte). Each bit time is a portion of a period of the CLK signal. For example, within a single period of the CLK signal, a first byte may be transmitted on a rising edge of the CLK signal, and a different byte may be transmitted on the falling edge of the CLK signal. In such a case, the bit time is half the period of the CLK signal. Bit times for which no value is provided in the figures may either be reserved or used to transmit command-specific or packet-specific information. Further, it should be understood that link widths other than 8 bits also are contemplated and that the link width of a particular point-to-point link may be different than the link width of other point-to-point links. In general, link widths of 2ⁿ (e.g., 2, 4, 8, 16, 32, 64, etc.) bits may be supported in the processing subsystem 12.

FIG. 4 illustrates an exemplary format for an information packet 40, which includes four bit times on an eight-bit communication link. The information packet 40 includes the command field CMD[5:0] in bit time 0, which carries the command encoding for the packet. Information packets are used for direct peer-to-peer communications and may be used to transmit flow control information (e.g., the freeing of packet buffers in a device, etc.), status information about the link (e.g., synchronization, errors, etc.). In an exemplary embodiment, information packets are not buffered or flow-controlled and are always accepted by the receiving device.

FIG. 5 is a diagram of an exemplary coherent sized request packet 42, which may be employed within processing subsystem 12. The sized request packet 42 may be used to initiate a sized transaction (e.g. a sized read or sized write transaction) and to transmit any requests associated with a particular transaction. Generally, a request packet indicates an operation to be performed by the target device.

The bits of a command field Cmd[5:0] identifying the type of request are transmitted during bit time 0. Bits of a source unit field SrcUnit[1:0] containing a value identifying a source unit within the source node are also transmitted during bit time 0. Types of units within computer system 10 may include memory controllers, caches, processors, etc. Bits of a source node field SrcNode[2:0] containing a value identifying the source node are transmitted during bit time 1. Bits of a destination node field DestNode[2:0] containing a value which uniquely identifies the destination device may also be transmitted during bit time 1, and may be used to route the packet to the destination device. Bits of a destination unit field DestUnit[1:0] containing a value identifying the destination unit within the destination device which is to receive the packet may also be transmitted during bit time 1.

Sized request packet 50 also may include bits of a source tag field SrcTag[4:0] in bit time 2 which, together with the unit ID[4:0] field, may link the packet to a particular transaction of which it is a part. Addr[7:2] in bit time 3 may be used in a sized request to transmit the least significant bits of the address affected by the transaction. Bit times 4-7 are used to transmit the bits of an address field Addr[39:8] containing the most significant bits of the address affected by the transaction. Some of the undefined fields in packet 42 may be used in various request packets to carry command-specific information.

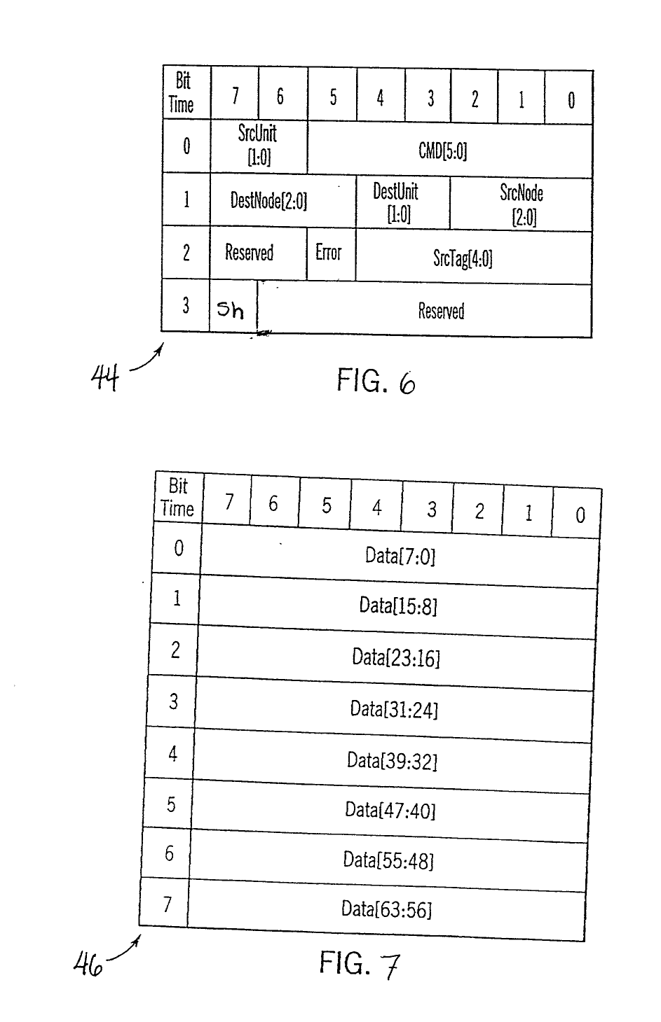

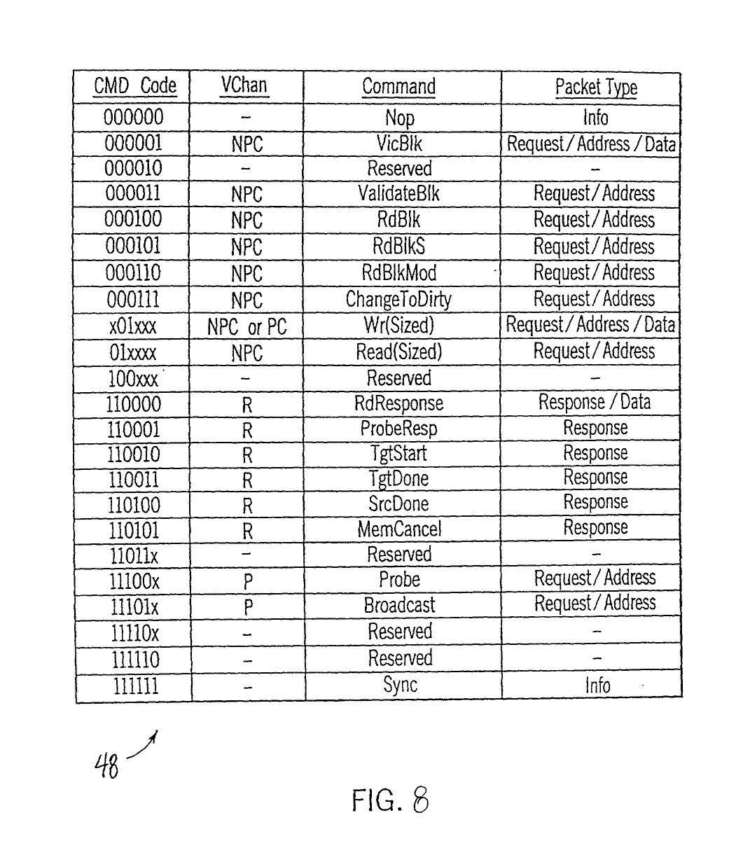

FIG. 6 is a diagram of an exemplary coherent response packet 44 which may be employed within processing subsystem 12. Response packet 44 includes the command field Cmd[5:0], the destination node field DestNode[2:0], and the destination unit field DestUnit[1:0]. The destination node field DestNode[2:0] identifies the destination device for the response packet (which may, in some cases, be the requester device or target device of the transaction). The destination unit field DestUnit[ 1:0] identifies the destination unit within the destination device. Various types of response packets may include additional information. For example, a read response packet may indicate the amount of read data provided in a following data packet. Probe responses may indicate whether or not a copy of the requested cache block is being retained by the probed device using the shared bit “Sh” in bit time 3.

Generally, response packet 44 is used for responses during the carrying out of a transaction which do not require transmission of the address affected by the transaction. Furthermore, response packet 44 may be used to transmit positive acknowledgement packets to terminate a transaction. Similar to the request packet 42, response packet 44 may include the source node field SrcNode[2:0], the source unit field SrcUnit[1:0], and the source tag field SrcTag[4:0] for many types of responses (illustrated as optional fields in FIG. 6).

FIG. 7 is a diagram of an exemplary coherent data packet 46 which may be employed within processing subsystem 12. Data packet 46 may comprise different numbers of bit times dependent upon the amount of data being transferred.

FIG. 8 is a table 48 listing different types of coherent packets which may be employed within processing subsystem 12. Other embodiments of processing subsystem 12 may employ other suitable sets of packet types and command field encodings. Table 48 includes a command code column including the contents of command field Cmd[5:0] for each coherent command, a command column including a mnemonic representing the command, and a packet type column indicating which of coherent packets 40, 42, and 44 (and data packet 46, where specified) is employed for that command. A brief functional description of some of the commands in table 48 is provided below.

A read transaction may be initiated using a sized read (Read(Sized) request, a read block (RdBlk) request, a read block shared (RdBlkS) request, or a read block with modify (RdBlkMod) request. The Read(Sized) request is used for non-cacheable reads or reads of data other than a cache block in size. The amount of data to be read is encoded into the Read(Sized) request packet. For reads of a cache block, the RdBlk request may be used unless: (i) a writeable copy of the cache block is desired, in which case the RdBlkMod request may be used; or (ii) a copy of the cache block is desired but no intention to modify the block is known, in which case the RdBlkS request may be used. The RdBlkS request may be used to make certain types of coherency schemes (e.g. directory-based coherency schemes) more efficient.

In general, to initiate the transaction, the appropriate read request is transmitted from the source device to a target device which owns the memory corresponding to the cache block. The memory controller in the target device transmits Probe requests to the other devices in the system to maintain coherency by changing the state of the cache block in those devices and by causing a device including an updated copy of the cache block to send the cache block to the source device. Each device receiving a Probe request transmits a probe response (ProbeResp) packet to the source device.

If a probed device has a modified copy of the read data (i.e., dirty data), that device transmits a read response (RdResponse) packet and the dirty data to the source device. A device transmitting dirty data may also transmit a memory cancel (MemCancel) response packet to the target device in an attempt to cancel transmission by the target device of the requested read data. Additionally, the memory controller in the target device transmits the requested read data using a RdResponse response packet followed by the data in a data packet.

If the source device receives a RdResponse response packet from a probed device, the received read data is used. Otherwise, the data from the target device is used. Once each of the probe responses and the read data is received in the source device, the source device transmits a source done (SrcDone) response packet to the target device as a positive acknowledgement of the termination of the transaction.

A write transaction may be initiated using a sized write (Wr(Sized)) request or a victim block (VicBlk) request followed by a corresponding data packet. The Wr(Sized) request is used for non-cacheable writes or writes of data other than a cache block in size. To maintain coherency for Wr(Sized)requests, the memory controller in the target device transmits Probe requests to each of the other devices in the system. In response to Probe requests, each probed device transmits a ProbeResp response packet to the target device. If a probed device is storing dirty data, the probed device responds with a RdResponse response packet and the dirty data. In this manner, a cache block updated by the Wr(Sized) request is returned to the memory controller for merging with the data provided by the Wr(Sized) request. The memory controller, upon receiving probe responses from each of the probed devices, transmits a target done (TgtDone) response packet to the source device to provide a positive acknowledgement of the termination of the transaction. The source device replies with a SrcDone response packet.

A victim cache block which has been modified by a device and is being replaced in a cache within the device is transmitted back to memory using the VicBlk request. Probes are not needed for the VicBlk request. Accordingly, when the target memory controller is prepared to commit victim block data to memory, the target memory controller transmits a TgtDone response packet to the source device of the victim block. The source device replies with either a SrcDone response packet to indicate that the data should be committed or a MemCancel response packet to indicate that the data has been invalidated between transmission of the VicBlk request and receipt of the TgtDone response packet (e.g. in response to an intervening probe).

A change to dirty (ChangetoDirty) request packet may be transmitted by a source device in order to obtain write permission for a cache block stored by the source device in a non-writeable state. A transaction initiated with a ChangetoDirty request may operate similar to a read transaction except that the target device does not return data. A validate block (ValidateBlk) request may be used to obtain write permission to a cache block not stored by a source device if the source device intends to update the entire cache block. No data is transferred to the source device for such a transaction, but otherwise operates similar to a read transaction.

A target start (TgtStart) response may be used by a target to indicate that a transaction has been started (e.g., for ordering of subsequent transactions). A no operation (NOP) info packet may be used to transfer flow control information between devices (e.g., buffer free indications). A Broadcast request packet may be used to broadcast messages between devices (e.g., to distribute interrupts). Finally, a synchronization (Sync) info packet may be used to synchronize device operations (e.g. error detection, reset, initialization, etc.).

Table 48 of FIG. 8 also includes a virtual channel (Vchan) column. The Vchan column indicates the virtual channel in which each packet travels (i.e., to which each packet belongs). In the present embodiment, four virtual channels are defined: a non-posted command (NPC) virtual channel, a posted command (PC) virtual channel, a response (R) virtual channel, and a probe (P) virtual channel.

Generally speaking, a “virtual channel” is a communication path for carrying packets between various processing devices. Each virtual channel is resource-independent of the other virtual channels (i.e., packets flowing in one virtual channel are generally not affected, in terms of physical transmission, by the presence or absence of packets in another virtual channel). Packets are assigned to a virtual channel based upon packet type. Packets in the same virtual channel may physically conflict with each other's transmission (i.e., packets in the same virtual channel may experience resource conflicts), but may not physically conflict with the transmission of packets in a different virtual channel.

Certain packets may logically conflict with other packets (i.e. for protocol reasons, coherency reasons, or other such reasons, one packet may logically conflict with another packet). If a first packet, for logical/protocol reasons, arrives at its destination device before a second packet arrives at its destination device, it is possible that a computer system could deadlock if the second packet physically blocks the first packet's transmission (e.g., by occupying conflicting resources). By assigning the first and second packets to separate virtual channels, and by implementing the transmission medium within the computer system such that packets in separate virtual channels cannot block each other's transmission, deadlock-free operation may be achieved. It is noted that the packets from different virtual channels are transmitted over the same physical links (e.g., links 18 in FIG. 2). However, because the communication protocol may dictate that a receiving buffer is available prior to transmission, the virtual channels do not block each other even while using this shared resource.

Each different packet type (e.g., each different command field Cmd[5:0]) could be assigned to its own virtual channel. However, the hardware to ensure that virtual channels are physically conflict-free may increase with the number of virtual channels. For example, in one embodiment, separate buffers in each processing device are allocated to each virtual channel. Since separate buffers are used for each virtual channel, packets from one virtual channel do not physically conflict with packets from another virtual channel (because such packets would be placed in the other buffers). It is noted, however, that the number of required buffers increases with the number of virtual channels. Accordingly, it is desirable to reduce the number of virtual channels by combining various packet types which do not conflict in a logical/protocol fashion. While such packets may physically conflict with each other when travelling in the same virtual channel, their lack of logical conflict allows for the resource conflict to be resolved without deadlock. Similarly, keeping packets which may logically conflict with each other in separate virtual channels provides for no resource conflict between the packets. Accordingly, the logical conflict may be resolved through the lack of resource conflict between the packets by allowing the packet which is to be completed first to make progress.

In one embodiment, packets travelling within a particular virtual channel on the coherent link from a particular source device to a particular destination device remain in order. However, packets from the particular source device to the particular destination device which travel in different virtual channels are not ordered. Similarly, packets from the particular source device to different destination devices, or from different source devices to the same destination device, are not ordered (even if travelling in the same virtual channel).

Packets travelling in different virtual channels may be routed through computer system 10 differently. For example, packets travelling in a first virtual channel from processing device 20B to processing device 20D may pass through processing device 20C, while packets travelling in a second virtual channel from processing device 20B to processing device 20D may pass through processing device 20E. Each processing device 20A-E may include circuitry to ensure that packets in different virtual channels do not physically conflict with each other.

A given write transaction may be a “posted” write transaction or a “non-posted” write transaction. Generally speaking, a posted write transaction is considered complete by the source device when the write request and corresponding data are transmitted by the source device (e.g., by an interface within the source device). A posted write operation is thus effectively completed at the source. As a result, the source device may continue with other transactions while the packet or packets of the posted write transaction travel to the target device and the target device completes the posted write transaction. The source device is not directly aware of when the posted write transaction is actually completed by the target device. It is noted that certain deadlock conditions may occur in Peripheral Component Interconnect (PCI) I/O systems if packets associated with posted write transactions are not allowed to pass traffic that is not associated with a posted transaction.

In contrast, a non-posted write transaction is not considered complete by the source device until the target device has completed the non-posted write transaction. The target device generally transmits an acknowledgement to the source device when the non-posted write transaction is completed. Such acknowledgements consume interconnect bandwidth and are to be received and accounted for by the source device. Non-posted write transactions may be required when the source device may need notification of when the request has actually reached its target before the source device can issue subsequent transactions.

A non-posted Wr(Sized) request belongs to the NPC virtual channel, and a posted Wr(Sized) request belongs to the PC virtual channel. In one embodiment, bit 5 of the command field Cmd[5:0] is used to distinguish posted writes and non-posted writes. Other embodiments may use a different field to specify posted and non-posted writes.

Non-Coherent Packets Within I/O Subsystem 14

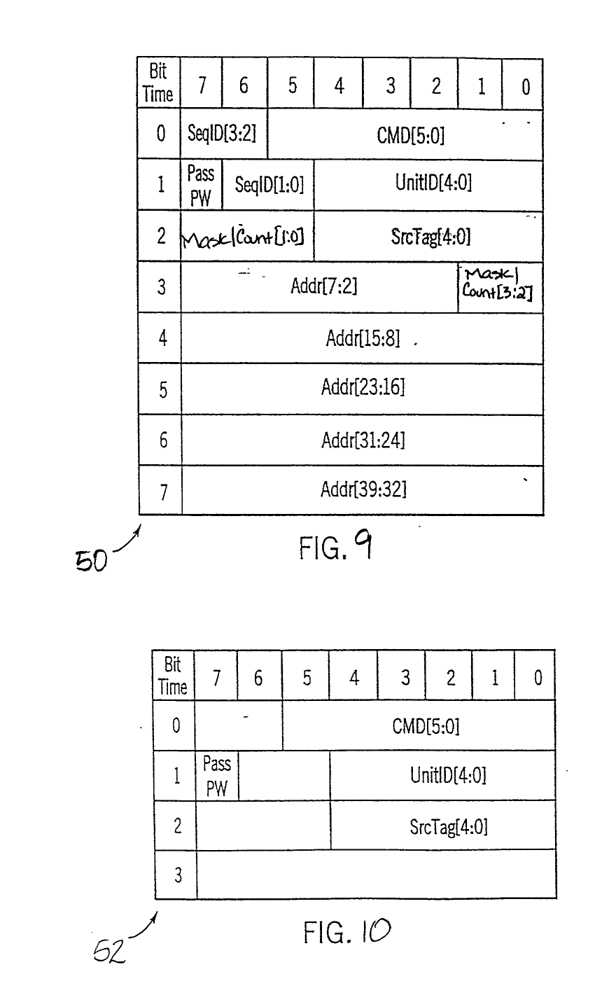

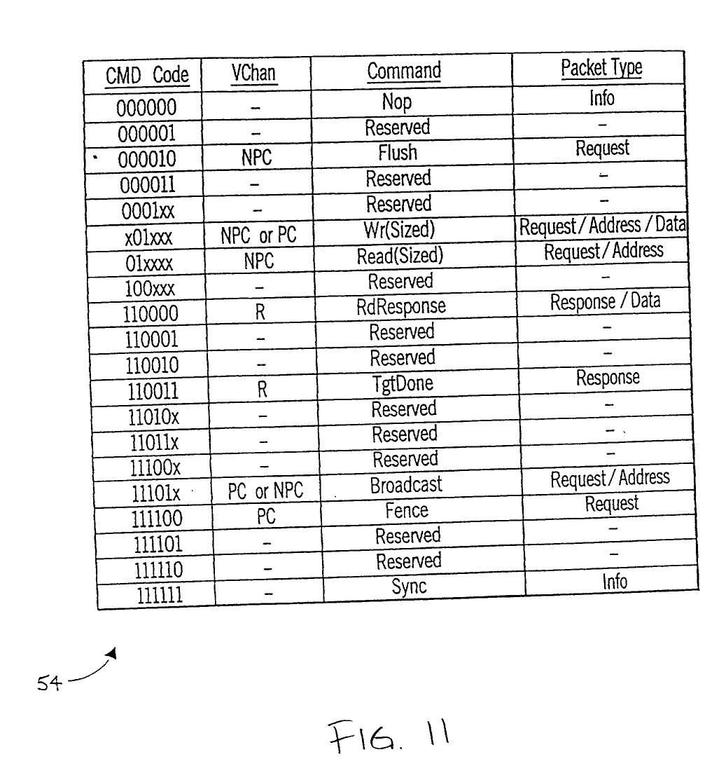

FIGS. 9 and 10 illustrate exemplary formats of the various types of non-coherent packets for an eight-bit communication link that may be used in one embodiment of the I/O subsystem 14. The packet formats show the contents of eight-bit bytes transmitted in parallel during consecutive bit times. The I/O subsystem 14 also supports link widths other than 8 bits. Further, as discussed above with respect to the processing subsystem 12, the link width of a particular point-to-point link may be different than the link width of other point-to-point links in the I/O subsystem 14. In general, link widths of 2ⁿ (e.g., 2, 4, 8, 16, 32, 64, etc.) bits may be supported in the I/O subsystem 14.

FIG. 9 is a diagram of an exemplary non-coherent sized request packet 50 which may be employed within I/O subsystem 14 on an 8-bit link. Request packet 50 includes command field Cmd[5:0] similar to command field Cmd[5:0] of the coherent request packet. Additionally, a source tag field SrcTag[4:0], similar to the source tag field SrcTag[4:0] of the coherent request packet, may be transmitted in bit time 2. The address affected by the transaction may be transmitted in bit times 4-7 and, optionally, in bit time 3 for the least significant address bits.

A unit ID field UnitID[4:0] in bit time 1 replaces the source node field SrcNode[2:0] of the coherent request packet. As discussed above, unit IDs identify the logical source or destination of the packets. An I/O device may have multiple unit IDs if, for example, the device includes multiple devices or functions which are logically separate. Accordingly, an I/O device may generate and accept packets having different unit IDs.

Additionally, request packet 50 includes a sequence ID field SeqID[3:0] transmitted in bit times 0 and 1. The sequence ID field SeqID[3:0] may be used to group a set of two or more request packets that are travelling in the same virtual channel and have the same unit ID. For example, if the SeqID field is zero, a packet is unordered with respect to other packets. If, however, the SeqID field has a non-zero value, the packet is ordered with respect to other packets in the same channel having a matching value in the SeqID field and the same UnitID.

Request packet 50 also includes a pass posted write (PassPW) bit transmitted in bit time 1. The PassPW bit indicates whether request packet 50 is allowed to pass posted write requests issued from the same unit ID. In an exemplary embodiment, if the PassPW bit is clear, the packet is not allowed to pass a previously transmitted posted write request packet. If the PassPW bit is set, the packet is allowed to pass prior posted writes. For read request packets, the command field Cmd[5:0] may include a bit having a state which indicates whether read responses may pass posted write requests. The state of that bit determines the state of the PassPW bit in the response packet corresponding to the read request packet.

Another feature of the request packet 50 is the Mask/Count[3:0] field in bit times 2 and 3. The Mask/Count field indicates which bytes within a data unit are to be read (mask) or encodes the number of data units to be transferred (count).

FIG. 10 is a diagram of an exemplary non-coherent response packet 52 which may be employed within I/O subsystem 14. Generally, the non-coherent response packet 52 is used for responses during the carrying out of a transaction that does not require transmission of the address affected by the transaction. Further, the response packet 52 may be used to transmit positive acknowledgements to terminate a transaction. Response packet 52 includes the command field Cmd[5:0], the unit ID field UnitID[4:0], the source tag field SrcTag[4:0], and the PassPW bit similar to request packet 50 described above. Other bits may be included in response packet 52 as needed.

Data packets and information packets also may be employed in the I/O subsystem 14. Such packets may be formatted in a similar manner as the coherent data packet illustrated in FIG. 7 and the coherent information packet illustrated in FIG. 4, respectively.

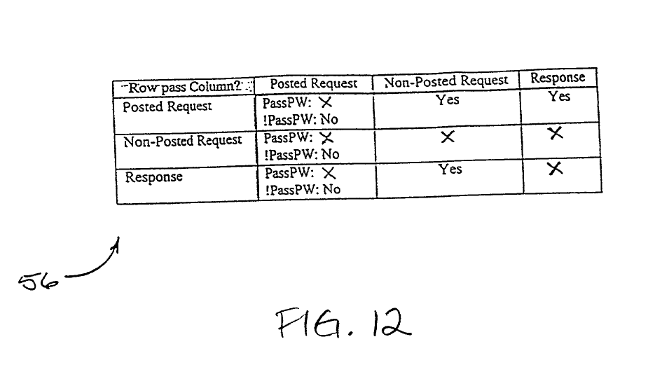

FIG. 11 illustrates a table 54 listing different types of non-coherent packets which may be employed within I/O subsystem 14. Other embodiments of I/O subsystem 14 may include other suitable sets of packets and command field encodings. Table 54 includes a command (CMD) code column listing the command encodings assigned to each non-coherent command, a virtual channel (Vchan) column defining the virtual channel to which the non-coherent packets belong, a command (Command) column including a mnemonic representing the command, and a packet type (Packet Type) column indicating which type of packet is employed for that command.

The NOP, Wr(Sized), Read(Sized), RdResponse, TgtDone, Broadcast, and Sync packets may be similar to the corresponding coherent packets described with respect to FIG. 8. However, within the I/O subsystem 14, neither probe request nor probe response packets are issued. Posted/non-posted write operations may again be identified by the value of bit 5 of the Wr(Sized) request, as described above, and TgtDone response packets may not be issued for posted writes.

A Flush request may be issued by an I/O device to ensure that one or more previously issued posted write requests have been observed at host memory. Generally, because posted requests are completed (e.g., the corresponding TgtDone response is received) on the requester device interface prior to completing the request on the target device interface, the requester device cannot determine when the posted requests have been flushed to their destination within the target device interface. A Flush applies only to requests in the same I/O stream as the Flush and may only be issued in the upstream direction. To perform its function, the Flush request travels in the non-posted command virtual channel and pushes all requests in the posted command channel ahead of it (i.e., via the PassPW bit). Thus, executing a Flush request (and receiving the corresponding TgtDone response packet) provides a means for the source device to determine that previous posted requests have been flushed to their targets within the coherent fabric.

The Fence request provides a barrier between posted writes which applies across all UnitIDs in the I/O subsystem 14. A Fence request may only be issued in the upstream direction and travels in the posted command virtual channel. The Fence pushes all posted requests in the posted channel ahead of it. For example, if the PassPW bit is clear, the Fence packet will not pass any packets in the posted channel, regardless of the UnitID of the packet. Other packets having the PassPW bit clear will not pass a Fence packet regardless of UnitID.

The table 54 also include a Virtual Channel (Vchan) column which specifies the virtual channel assigned to the packet with the particular coding provided in the table 54. In the exemplary embodiment, the fabric of the I/O subsystem 14 supports three types of virtual channels: (1) a posted command (PC) virtual channel; (2) a non-posted command (NPC) virtual channel; and (3) a response (R) virtual channel. Because probe packets are not used in the non-coherent fabric (i.e., data is not cached in the I/O subsystem 14), a probe virtual channel is not implemented.

Packet Ordering Rules Within I/O Subsystem 14

As described above, non-coherent packets transmitted within I/O subsystem 14 are either transmitted in an upstream direction toward a bridge device 16 or 22 or in a downstream direction away from the bridge device 16 or 22, and may pass through one or more intermediate I/O devices. The bridge devices 16 and 22 receive non-coherent memory request packets from I/O subsystem 14, translate the non-coherent memory request packets to corresponding coherent request packets, and issue the coherent request packets within processing subsystem 12. In an exemplary embodiment, certain transactions are completed in the order in which they were generated to preserve memory coherency within computer system 10 and to adhere to certain I/O ordering requirements expected by the I/O devices. For example, PCI I/O subsystems may define certain ordering requirements to assure deadlock-free operation. Accordingly, each processing device 20 and I/O device 32 and 36 implements ordering rules with regard to memory operations to preserve memory coherency within computer system 10 and to adhere to I/O ordering requirements.

The I/O devices 32A-C and 36A-B within the I/O subsystem 14 implement the following upstream ordering rules regarding packets in the non-posted command (NPC) channel, the posted command (PC) channel, and the response (R) channel:

1) packets from different source I/O devices are in different I/O streams and are not ordered with respect to one another;

2) packets in the same I/O stream and virtual channel that are part of a sequence (i.e., have matching nonzero SeqIDs) are strongly ordered, and may not pass each other; and

3) packets from the same source I/O device (i.e., traveling in the same I/O stream), but not in the same virtual channel or not part of a sequence, may be forwarded ahead of (i.e., pass) other packets in accordance with the passing rules set forth in table 56 in FIG. 12.

In table 56 of FIG. 12, a “No” entry indicates a subsequently issued request/response packet listed in the corresponding row of table 56 is not allowed to pass a previously issued request/response packet listed in the corresponding column of table 56. For example, request and/or data packets of a subsequently issued non-posted write transaction are not allowed to pass request and/or data packets of a previously issued posted write transaction if the PassPW bit is clear (e.g., a “0”) in the request packet of the subsequently issued non-posted write request transaction. Such “blocking” of subsequently issued requests may be required to ensure proper ordering of packets is maintained. It is noted that allowing packets traveling in one virtual channel to block packets traveling in a different virtual channel represents an interaction between the otherwise independent virtual channels within the I/O subsystem 14.

A “Yes” entry in table 56 indicates a subsequently issued request/response packet listed in the corresponding row of table 56 cannot be blocked by a previously issued request/response packet listed in the corresponding column of table 56. For example, request and/or data packets of a subsequently issued posted write transaction pass request and/or data packets of a previously issued non-posted write transaction. In an exemplary embodiment, such passing ensures prevention of a deadlock situation within computer system 10.

An “X” entry in table 56 indicates that there are no ordering requirements between a subsequently issued request/response packet listed in the corresponding row of table 56 and a previously issued request/response packet listed in the corresponding column of table 56. For example, there are no ordering requirements between request and/or data packets of a subsequently issued non-posted write transaction and request and/or data packets of a previously issued non-posted write transaction. The request and/or data packets of the subsequently issued non-posted write transaction may be allowed to pass the request and/or data packets of the previously issued non-posted write transaction if there is any advantage to doing so.

I/O Transaction Ordering Rules Within Processing Subsystem 12

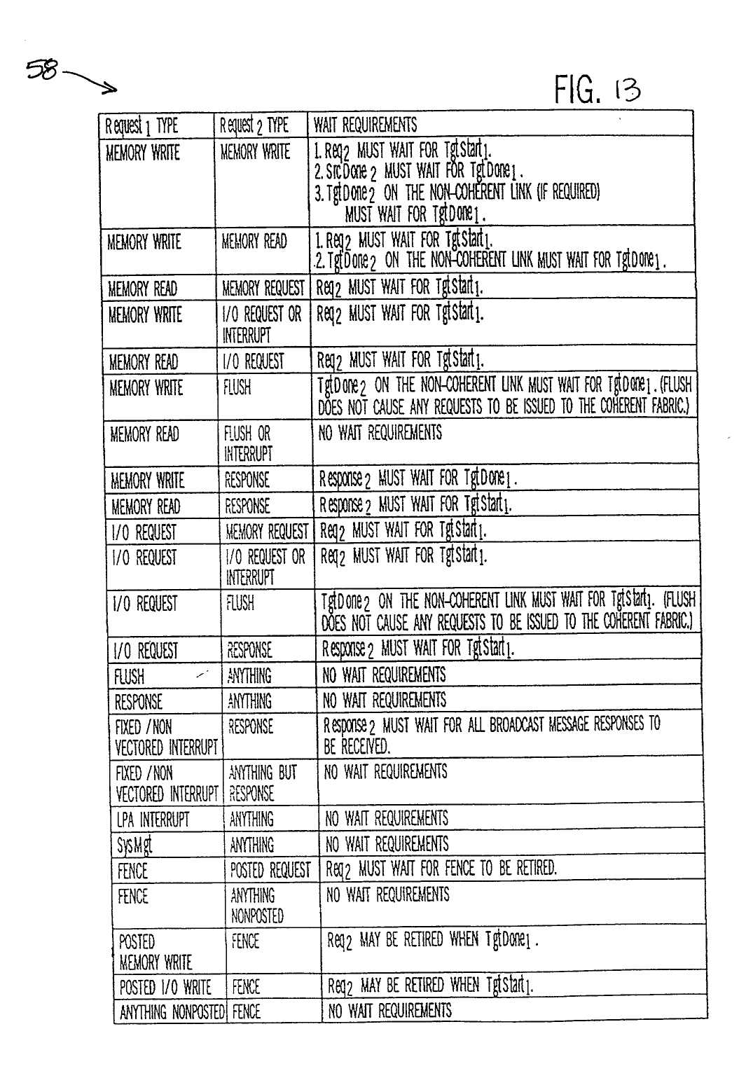

As described above, the bridge devices 16 and 22 translate packets between processing subsystem 12 and I/O subsystem 14. Turning now to FIG. 13, a table 58 is shown illustrating operation of one embodiment of the bridge device 16 or 22 in response to a pair of ordered requests received from a particular unit within the non-coherent fabric. The only ordering rule provided by the coherent fabric itself is that packets travelling in the same virtual channel, from the same source to the same destination, are guaranteed to remain in order. However, due to the distributed nature of the coherent fabric, I/O streams entering the coherent fabric may be spread over multiple targets. Thus, to guarantee ordering from the point of view of all observers, the bridge device 16 or 22 waits for responses to prior packets before issuing new packets into the coherent fabric. In this manner, the bridge device 16 or 22 may determine that the prior packets have progressed far enough into the coherent fabric for subsequent packets to be issued without disturbing ordering.

The bridge device 16 or 22 may determine which of the packets coming from the non-coherent fabric have ordering requirements. Such a determination may be accomplished by examining the command encoding, UnitID, SeqID, PassPW fields in each of the packets, and applying the rules from table 56. Unordered packets require no special action by the bridge device 16 or 22; they may be issued to the coherent fabric in any order as quickly as they may be transmitted by the bridge device 16 or 22. Ordered packets, on the other hand, have various wait requirements which are listed in table 58.

Table 58 includes a Request, column listing the first request of the ordered pair, a Request column listing the second request of the ordered pair, and a wait requirements column listing responses that are to be received before the bridge device 16 or 22 may allow the second request to proceed.

Unless otherwise indicated in table 58, the referenced packets are on the coherent fabric. Also, in an exemplary embodiment, combinations of requests which are not listed in table 58 do not have wait requirements. Still further, table 58 applies only if the bridge device 16 or 22 first determines that ordering requirements exist between two request packets. For example, ordering requirements may exist if the two request packets have matching non-zero sequence IDs, or if the first request packet is a posted write and the second request has the PassPW bit clear.

In the first entry of table 58, a pair of ordered memory write requests are completed by the bridge device 16 or 22 by delaying transmission of the second memory write request until a TgtStart packet corresponding to the first memory write request is received in the coherent fabric by the bridge device 16 or 22. Additionally, the bridge device 16 or 22 withholds a SrcDone packet corresponding to the second memory write request until a TgtDone packet corresponding to the first memory write request has been received. Finally, the TgtDone packet corresponding to the second memory write request on the non-coherent link (if the memory write is a non-posted request) is delayed until the TgtDone packet corresponding to the first memory write request has been received from the coherent fabric. The other entries in the table 58 of FIG. 13 may be interpreted in a manner similar to the description given above for the first entry.

Thus, in general, I/O subsystem 14 provides a first transaction Request, and a second transaction Request₂ to the bridge device 16 or 22, the Request₂ following the Request₁. The bridge device 16 or 22 dispatches Request, within processing subsystem 12 and may dispatch Request₂ within processing subsystem 12 dependent upon the progress of Request₁. Alternatively, the bridge device 16 or 22 may delay completion of Request₂ with respect to Request₁.

Implementation of Interrupt Requests Within Computing System 10

Interrupt requests may be generated in the coherent fabric by any of the processing devices 20A-E or in the non-coherent fabric by any of the I/O devices 32A-C and 36A-B and then issued into the coherent fabric through a bridge device 16 or 22. The handling of an interrupt request in the coherent fabric is the same regardless of whether the interrupt request was sourced in the coherent fabric or issued into the coherent fabric from the non-coherent fabric. In the point-to-point link computing system 10, interrupt requests are implemented using particular types of packets and the ordering rules set forth in tables 56 and 58, as will be described below.

In general, in the non-coherent fabric of the I/O subsystem 14, an interrupt request is generated by a source I/O device using a non-coherent posted sized write (WrSized) request packet issued to an address range that has been reserved for interrupt requests. The WrSized request packet is transmitted to the bridge device 16 or 22, which translates the packet to a coherent broadcast interrupt packet that is sent to all processing devices 20A-E in the coherent fabric. Similarly, if the interrupt request is initiated by a processing device 20A-E, the processing device 20A-E generates the interrupt request by issuing a broadcast interrupt packet to all other processing devices 20A-E in the coherent fabric.

In an exemplary embodiment, in accordance with the ordering rules set forth in table 56 of FIG. 12 for packets in the I/O subsystem 14, the non-coherent WrSized interrupt request packet pushes previously issued posted write request packets if the PassPW bit in the interrupt request packet (see FIG. 14) is clear. In accordance with the wait requirements set forth in table 58 of FIG. 13 for packets sourced from the non-coherent fabric onto the coherent fabric by a bridge device, all previously issued posted write request packets will be visible at their respective target processing devices 20A-E before the bridge device issues the interrupt request packet onto the coherent fabric.

FIG. 14 illustrates an exemplary format of a non-coherent posted WrSized packet 60 used for an interrupt request generated by an I/O device 32A-C or 36A-B. FIG. 15 illustrates an exemplary format of a coherent broadcast interrupt packet 62 issued onto the coherent fabric by either the bridge device 16 or 22 or a processing device 20A-E. Other embodiments of computing system 10 may employ interrupt request packets having different formats than the packets illustrated in FIGS. 14 and 15.

The exemplary format of the WrSized interrupt request packet 60 of FIG. 14 includes the Cmd[5:0], SeqID [3:0], UnitID[4:0], SrcTag[4:0], and Count[3:0] fields, and the PassPW bit as described above with respect to the non-coherent sized request packet 50 illustrated in FIG. 9. The address fields[39:24] in bit times 6 and 7 include an address within the address range reserved for interrupts. The address fields[23:8] in bit times 4 and 5 of the interrupt request packet 60 include an interrupt destination IntrDest[7:0] field and a vector ID Vector[7:0] field. The contents of the IntrDest[7:0] field indicate the address corresponding to the destination for the interrupt request in the coherent fabric. The contents of the Vector[7:0] field identify the source of the interrupt request.

The interrupt request packet 60 also includes a Message Type MT[2:0] field, a Trigger Mode TM bit, and a destination mode DM bit in the address field[6:2] of bit time 3. The MT field identifies the class of interrupt request. For example, the encoding of the MT field may indicate that the interrupt is a fixed interrupt, an arbitrated (or lowest priority) interrupt, or a type of non-vectored interrupt. Types of non-vectored interrupts include a system management interrupt (SMI), a non-maskable interrupt (NMI), an initialization interrupt (INIT), a startup interrupt (Startup), and an external interrupt (Ext Int). In one embodiment, the MT field also may be encoded to indicate that the packet is an End of Interrupt (EOI) message, as will be described below.

For all classes of interrupts, the set of potential destinations for an interrupt request is specified by the IntrDest field and the DM bit. The DM bit indicates whether the IntrDest field represents a physical mode identifier (i.e., a physical address) or a logical mode identifier (i.e., a mask). In the physical mode, each potential interrupt destination (i.e., a processor within a processing device 20A-E) in the processing subsystem 12 is assigned a unique physical ID from a set of physical IDs. In the exemplary embodiment, the physical ID is an 8-bit ID. Further, one of the physical IDs is reserved and used to indicate that the interrupt should be broadcast to all possible destinations (i.e., the broadcast interrupt destination ID). A destination is considered a target for a physical mode interrupt if its assigned physical ID matches the contents of the IntrDest field or if the IntrDest field contains the broadcast physical ID.

In the logical mode, each potential interrupt destination is assigned a logical ID. The contents of the IntrDest field may represent a mask corresponding to the logical ID. Thus, in an exemplary embodiment, to determine whether a processing device is a target for a logical mode interrupt, the device may examine the contents of the IntrDest field to determine the presence of a set bit corresponding to the device's logical ID.

In the exemplary embodiment, the encoding of the TM field specifies whether the particular interrupt request is an edge-triggered interrupt or a level-sensitive interrupt. Arbitrated and fixed interrupt requests may be either edge triggered or level sensitive, while non-vectored interrupts always are edge triggered. An edge-triggered interrupt is issued on an edge transition of an interrupt signal. A level-sensitive interrupt, on the other hand, is issued whenever the interrupt signal is at a certain level (e.g., a HIGH level, a value of “1,” etc.).

FIG. 15 illustrates an exemplary format of the coherent broadcast interrupt packet 62 which is issued onto the coherent fabric by either a processing device 20A-E that is initiating an interrupt request (i.e., a cross interrupt) or a bridge device 16 or 22 that is forwarding an interrupt request from the non-coherent fabric. The TgtNode[2:0] field in the broadcast interrupt packet 62 contains the source Node ID of the device initiating the broadcast (e.g., a processing device 20A-E, the bridge device 16 or 22, etc.), and the TgtUnit field contains the unit ID of the unit within the initiating device to which a response to the broadcast interrupt packet should be sent. The SrcNode and SrcUnit fields of the broadcast interrupt packet 62 may or may not contain the same values as the TgtNode and TgtUnit fields, depending on whether the device identified in the TgtNode and TgtUnit fields was the original source of the interrupt transaction.

The broadcast interrupt packet 62 includes the Cmd[5:0] field as described above with respect to the coherent request packet 42 illustrated in FIG. 5. The address fields[39:24] in bit times 6 and 7 include an address within the address range reserved for interrupts. The address fields[23:8] in bit times 4 and 5 of the broadcast interrupt packet 62 include the IntrDest[7:0] field and Vector[7:0] field as described above with respect to the non-coherent interrupt request packet 60. The address field[6:2] in bit time 3 contain the information (i.e., the MT[2:0] field and the DM and TM bits) which specifies the interrupt type.

FIGS. 16 and 17 diagrammatically illustrate the events associated with an exemplary interrupt transaction corresponding to the fixed and non-vectored classes of interrupts (i.e., FIG. 16) and the arbitrated class of interrupts (i.e., FIG. 17). As discussed above, the computing system 10 supports both cross interrupts (i.e., interrupt requests issued by processing devices 20A-E in the processing subsystem 12) and interrupt requests sourced from the I/O devices 32A-C and 36A-B in the I/O subsystem 14. The diagrams shown in FIGS. 16 and 17 illustrate the propagation of an interrupt request initiated by an I/O device that is issued into the coherent fabric of the processing subsystem 12. It should be understood, however, that the propagation of a cross interrupt proceeds in a similar manner except that the events which occur in the non-coherent fabric of the I/O subsystem 14 are omitted. Thus, in both FIGS. 16 and 17, if the interrupt request is a cross interrupt, then the symbol HB in the diagrams represents the processing device 20A-E which sources the interrupt request. Further, although the diagrams in FIGS. 16 and 17 illustrate responses generated as a result of the interrupt request, it should be understood that the generation of responses is dependent upon the particular ordering needs of the application being implemented by the computing system 10.

With reference to FIG. 16, the propagation of fixed and non-vectored interrupts is illustrated. Although fixed and non-vectored interrupts are broadcast to all processing devices 20A-E in the processing subsystem 12, the broadcast message is directed at a particular target. That is, the target of the fixed or non-vectored interrupt is identified in the IntrDest[7:0] field of the broadcast interrupt packet. The MT field in the broadcast interrupt packet is set to the appropriate message type (e.g., SMI, NMI, INIT, Ext Int, Startup, etc.). Fixed interrupts also include a vector ID in the Vector[7:0] field to identify the source of the interrupt, while non-vectored interrupt requests do not specify a source in the vector ID field.

If the fixed or non-vectored interrupt request is initiated by an I/O device (I/O), then the I/O device issues a non-coherent posted WrSized interrupt request packet (WS(I)(NC)) (i.e., packet 60 of FIG. 14) to its host bridge (HB) device (e.g., the bridge device 16 or 22). The bridge device decodes the packet, translates the packet to either a posted or non-posted coherent broadcast interrupt packet (BM(I)(C)) (i.e., packet 62 of FIG. 15), and issues the broadcast interrupt packet to all processing devices (CPU) within the coherent fabric of the processing subsystem 12 with the target specified in the IntrDest field of the packet.

Each processing device decodes the broadcast packet and determines, based on the decoding (e.g., by examining the IntrDest field and the MT bit), whether the interrupt request is targeted at the processor associated with the processing device 20A-E. The processing device owning the targeted processor (i.e., as indicated in the IntrDest Field) delivers the interrupt to the processor for servicing. More than one processor may be targeted by the interrupt request and, thus, the interrupt may be delivered to more than one processor for servicing.

In one embodiment, a response acknowledging the broadcast interrupt packet may be desired. In such an embodiment, the bridge device may set a bit in the broadcast interrupt pakcet to indicate that a response should be issued. If the broadcast interrupt packet issued by the bridge device indicates a response, then all processing devices, regardless of whether targeted by the interrupt request, acknowledge receipt of the broadcast interrupt packet by issuing a coherent probe response packet (R(P)(C)) back to the bridge device.

The coherent probe response packet may be formatted as described above for the coherent response packet 44 illustrated in FIG. 6. The values in the SrcNode, SrcUnit, and SrcTag fields of the probe response packet are derived from the corresponding fields in the broadcast packet. The values contained in the DestNode and DestUnit fields of the read response packet are derived from the TgtNode and TgtUnit fields, respectively, of the broadcast packet.

FIG. 17 illustrates the propagation of an arbitrated (or lowest priority) interrupt sourced by an I/O device and issued onto the coherent fabric of the processing subsystem 12. An arbitrated interrupt ultimately is delivered to only one destination of the set of possible destinations addressed by the interrupt request. That is, the arbitrated interrupt is broadcast to all processing devices 20A-E in the coherent fabric with the IntrDest field specifying the targeted processor or processors. However, because the request is an arbitrated request (i.e., as indicated by the MT bit), the interrupt request is not delivered to the target processors. Instead, all processing devices transmit responses to the request, and based on these responses, the arbitrated interrupt ultimately is delivered to a selected target processor. The ultimate target processor that services the interrupt request is either the processor in a processing device 20A-E having the lowest priority or the processor in a processing device 20A-E that already is servicing an interrupt from the same interrupt source (i.e., the “focus” processor). The source of an arbitrated interrupt is identified by the vector ID in the interrupt packet.

In FIG. 17, the I/O device (I/O) generates a non-coherent posted WrSized interrupt request packet (WS(I)(NC)) (i.e., packet 60) to its host bridge (HB) (e.g., the bridge device 16 or 22). The bridge device decodes the interrupt request packet, translates the packet to a coherent broadcast interrupt packet (BM(I)(C)) with the MT bit indicating a low priority interrupt message, and the IntrDest field containing the target identifier. The bridge device also may set a bit in the broadcast interrupt packet indicating that a probe response is to be returned to the bridge device. The bridge device transmits the broadcast packet to all the processing devices 20A-E in the processing subsystem 12.

Each processing device 20A-E receives and decodes the interrupt request packet to determine if the processing device is a target of the interrupt request (e.g., by examining the IntrDest field and the MT bit). If the MT bit indicates that the interrupt request is an arbitrated interrupt, then each processing device 20A-E responds with a coherent read response packet (i.e., see FIG. 6), regardless of whether the processing device is a target. At this point, however, none of the processing devices deliver the interrupt request to a processor for servicing. The values in the SrcNode, SrcUnit, and SrcTag fields of the read response packet are derived from the corresponding fields in the broadcast packet. The values contained in the DestNode and DestUnit fields of the read response packet are derived from the TgtNode and TgtUnit fields, respectively, of the broadcast packet.

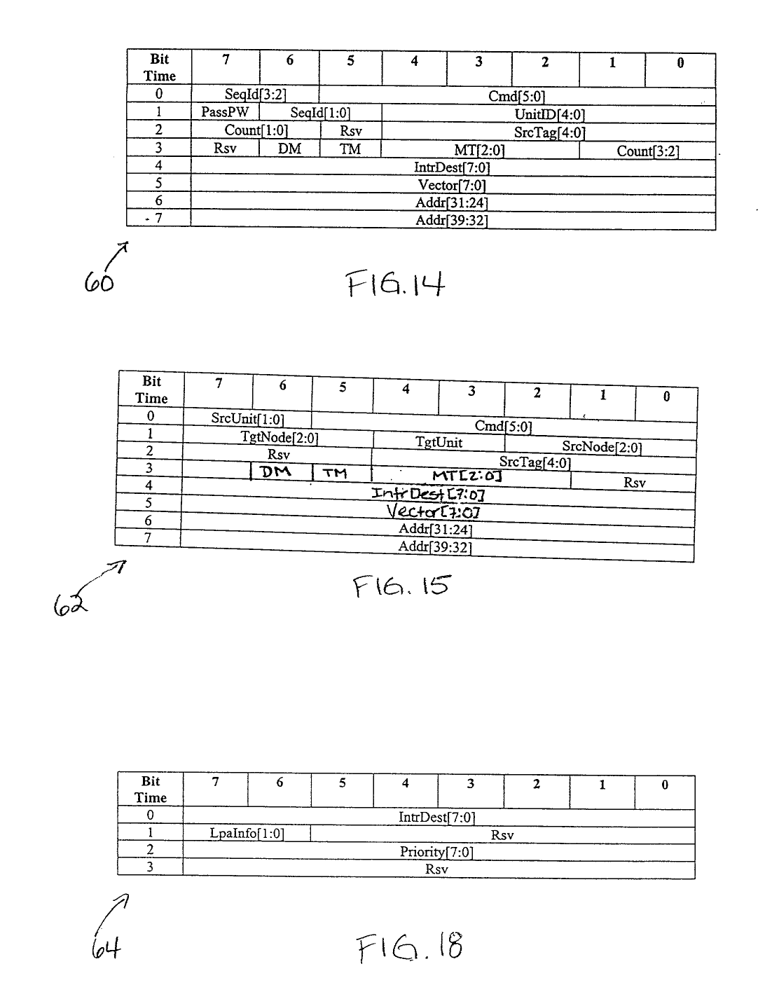

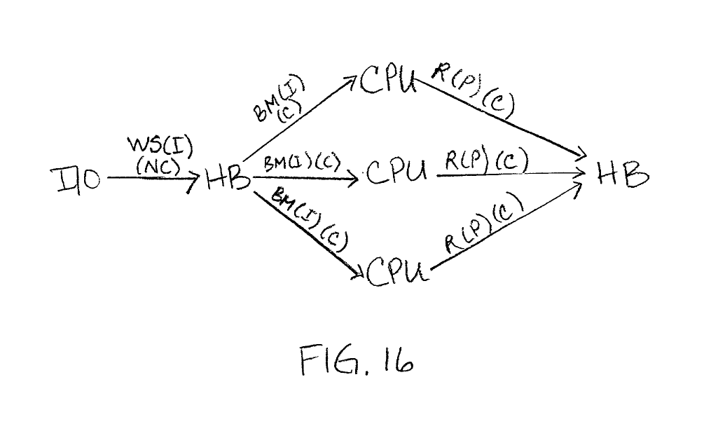

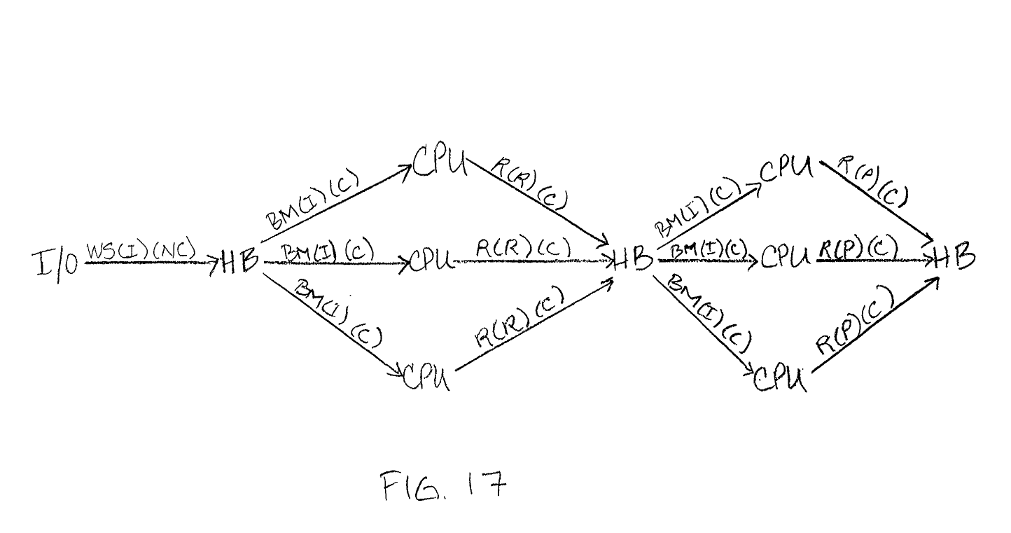

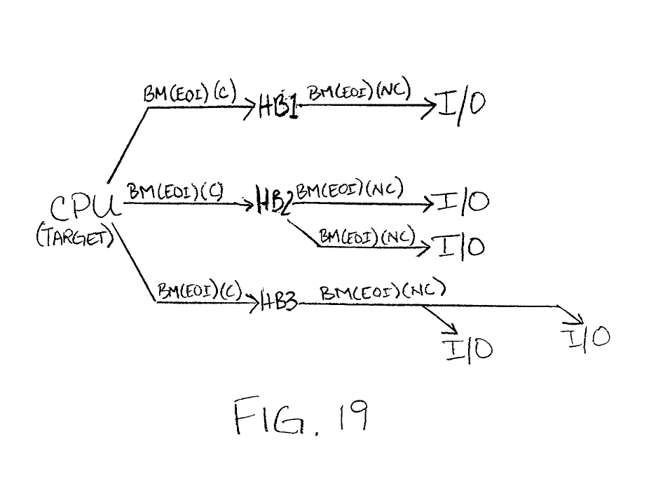

The read response packet also has an associated data packet containing a single doubleword of data. An exemplary embodiment of a data packet 64 for the read response is illustrated in FIG. 18. With reference to FIG. 18, the data packet 64 includes an interrupt destination IntrDest[7:0] field in bit time 0 which contains the interrupt destination ID associated with the processor of the processing device 20A-E which is providing the response. If more than one processor is associated with the processing device 20A-E, then the IntrDest field contains the interrupt destination ID of the processor which is at the lowest priority level or which has declared itself the focus processor.

Bit time 1 of the data packet 64 includes a low priority arbitration information Lpalnfo[1:0] field which contains additional information about the response. For example, the encoding of the LpaInfo[1:0] field may indicate that either (1) the responding processing device 20A-E was not a target of the broadcast interrupt packet (i.e., as determined by the IntrDest field in the broadcast packet); (2) the responding processing device 20A-E was a target of the broadcast interrupt packet, but is not a focus processor; or (3) the responding processing device 20A-E was a target of the broadcast interrupt packet and is declaring itself the focus processor.

Bit time 2 of the data packet 64 includes a Priority[7:0] field which indicates the interrupt priority level of the responding processing device 20A-E. Thus, a processing device 20A-E that was targeted by the broadcast interrupt packet, indicates that its processor is the target by placing the proper encoding in the Lpalnfo[1:0] field and specifying the interrupt priority level of the processor in the Priority[7:0] field in the data packet 64.

When the device (i.e., HB) which initiated the broadcast interrupt packet has received response packets from all other processing devices 20A-E in the coherent fabric, the initiating device examines the priority information in all of the response packets and determines, based on an appropriate priority algorithm, which processing device 20A-E should service the interrupt request. For example, if multiple processing devices 20A-E return the same priority information, then the initiating device (HB) may select one of the processing devices 20A-E based on a fair arbitration algorithm. Alternatively, if one of the processing devices 20A-E has the focus processor (i.e., a processor which already is servicing an interrupt from the same source), then the initiating device (HB) may select the focus processor.

After selection of the processor within the processing devices 20A-E, the initiating device (HB) issues a coherent broadcast interrupt packet (BM(I)(C)) (i.e., packet 60) to all processing devices 20A-E. This broadcast packet is a directed broadcast packet in that the IntrDest[7:0] field of the broadcast packet contains the IntrDest ID of the selected processor. This IntrDest ID is derived from the IntrDest[7:0] field in bit time 1 of the data packet containing the priority information associated with the selected processor. Each processing device 20A-E accepts the broadcast interrupt packet, decodes the information, and determines, based on the decoding, whether the interrupt should be delivered to its processor for servicing. If the directed broadcast packet was a non-posted packet, then all processing devices 20A-E acknowledge receipt of the directed broadcast packet with a coherent probe response packet (R(P)(C)), regardless of whether the processing device was the target of the interrupt.

The foregoing discussion assumes that the initiating device is unable to decode the IntrDest field in the read response packet and, thus, does not know how to direct the interrupt request to only the selected processor. Accordingly, the initiating device sends the directed broadcast interrupt request to all processing devices 20A-E in the processing subsystem. Each processing device 20A-E is responsible for determining whether it is the processing device which owns the selected processor and, if so, to deliver the interrupt request to its processor. In alternative embodiments, the initiating device may be configured to decode the IntrDest field and thus may transmit the interrupt request only to the selected device for servicing.

In the exemplary embodiment, to comply with the packet ordering rules and the wait requirements for bridge devices set forth in tables 56 and 58, an End of Interrupt (EOI) message is generated to acknowledge completion of service of a level-sensitive interrupt request and is broadcast to all processing devices 20A-E in the processing subsystem 12 and all I/O devices 32A-C and 36A-B in the I/O subsystem 14, as illustrated in FIG. 19. In the exemplary embodiment, devices which receive an interrupt are not configured to decode the data (i.e., the Vector[7:0] field) identifying the device that sourced the interrupt. Thus, to ensure that the sourcing device receives the EOI message, the EOI message is sent in broadcast message packets to the reserved interrupt address range to all processing devices 20A-E in the coherent fabric. The EOI message also is translated to non-coherent EOI broadcast message packets by the bridge devices 16 and 22 and forwarded to all I/O devices 32A-C and 36A-B in the non-coherent fabric.

In the coherent fabric, the EOI broadcast packet is similar to the coherent broadcast interrupt packet 62 illustrated in FIG. 15. Likewise, the non-coherent EOI broadcast packet is similar to the non-coherent WrSized interrupt request packet 60 illustrated in FIG. 14. The Vector[7:0] field in bit time 5 of both the coherent and non-coherent EOI packets contains the interrupt vector of the interrupt that is being acknowledge and, thus, contains the same vector ID that was included in the Vector[7:0] field of the corresponding broadcast interrupt packet. The MT[2:0] field in bit time 3 of the EOI packets indicates that the message is an EOI message. The DM, TM, and IntrDest fields are not used in an EOI packet.

FIG. 19 illustrates the propagation of an EOI message in the coherent and non-coherent fabrics. The target device (CPU (Target)) which has serviced the interrupt acknowledges completion of servicing by issuing a coherent EOI broadcast packet to all other processing devices 20A-E in the coherent fabric, as well as to all bridge devices (HB) (e.g., bridge devices 16 and 22). In the diagram of FIG. 19, the computing system 10 includes three bridge devices designated as HB1, HB2, and HB3. Each bridge device translates the coherent EOI packet into a non-coherent EOI packet and transmits the EOI packet to all I/O devices downstream of the respective bridge device. In the embodiment illustrated in FIG. 19, the bridge device HB1 is connected to a single chain having a single I/O device. The bridge device HB2 is connected to two chains, each having a single I/O device, and the bridge device HB3 is connected to a single chain of two I/O devices.

Both the processing devices and the I/O devices which receive the EOI packet decode the packet to determine whether the packet is an acknowledgement to an interrupt that the receiving device had previously issued. For example, if the MT field indicates that the packet is an EOI message and the contents of the Vector[7:0] field match the vector ID of an interrupt previously issued by the device receiving the EOI packet, then the packet is an acknowledgement of an interrupt sent by the receiving device. The receiving device determines whether the interrupt corresponding to the vector ID is still pending internally (i.e., whether additional interrupt tasks associated with the original interrupt request remain to be done). If so, then the receiving device may issue a new interrupt request packet corresponding to an additional interrupt task. The bridge devices may implement filtering to avoid sending unnecessary EOI messages down the non-coherent chains. For example, an exemplary filtering algorithm may implement a register for each non-coherent chain, with each bit of the register representing an interrupt vector ID value. At reset of the computing system 10, all bits of the register may be set to a value of “0.” Each time an interrupt request is delivered from the non-coherent fabric, the appropriate vector ID bit in the register corresponding to the non-coherent link issuing the interrupt request is set to a value of “1.” Thus, a bridge device would forward to the non-coherent chain only those EOI messages with a vector ID corresponding to a set bit in the filtering register.

In the description provided above of the computing system, communications on the communication link are packet based. However, it is contemplated that the communications may be transmitted in formats other than packets. Further, while the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method of implementing interrupt requests in a computing system comprising a plurality of devices interconnected by a plurality of point-to-point links, the plurality of devices including a plurality of processing devices, the method comprising the acts of:
transmitting, on the plurality of point-to-point links, an interrupt request packet to each of the plurality of processing devices, the interrupt request packet comprising an interrupt request; and
determining at each of the processing devices if the processing device comprises a target of the interrupt request packet.

2. The method as recited in claim 1, wherein if the processing device comprises the target, the method comprises the act of servicing the interrupt request.

3. The method as recited in claim 1, comprising the act of:
transmitting, on the plurality of point-to-point links, from each of the plurality of processing devices, a response packet to acknowledge receipt of the interrupt request packet.

4. The method as recited in claim 3, comprising the acts of:
determining if the interrupt request comprises an arbitrated interrupt request; and
if the processing device comprises the target of the arbitrated interrupt request,
providing, with the response packet, priority data representing a priority level of the processing device;
selecting, based on the priority data in the response packets, a processing device of the plurality of processing devices to service the arbitrated interrupt request; and
transmitting a directed interrupt request packet comprising the arbitrated interrupt request to the selected processing device.

5. The method as recited in claim 4, wherein the priority data identifies a presence of a focus processor, and wherein the selected processing device comprises the focus processor.

6. The method as recited in claim 4, comprising the acts of:
broadcasting, on the plurality of point-to-point links, the directed interrupt request packet to each of the plurality of processing devices;
determining at each of the processing devices if the processing device is a target of the directed interrupt request packet; and
if the processing device is the target, servicing the arbitrated interrupt request.

7. The method as recited in claim 6, comprising the act of:
transmitting, on the plurality of point-to-point links, from each of the plurality of processing devices, a response packet to acknowledge receipt of the directed interrupt request packet.

8. The method as recited in claim 3, wherein the interrupt request packet is transmitted by a first device of the plurality of devices, and wherein each of the response packets is returned to the first device.

9. The method as recited in claim 8, wherein a first processing device of the plurality of processing devices comprises the first device.

10. The method as recited in claim 8, wherein the plurality of devices comprises a plurality of input/output (I/O) devices, wherein the plurality of I/O devices is connected to the plurality of processing devices by a bridge device, and wherein the first device comprises the bridge device.

11. The method as recited in claim 10, wherein a first processing device of the plurality of processing devices comprises the first device.

12. The method as recited in claim 10, comprising the acts of:
generating at a first I/O device of the plurality of I/O devices a request packet comprising the interrupt request;
transmitting the request packet to the bridge device; and
translating the request packet to the interrupt request packet.

13. The method as recited in claim 2, comprising the act of:
transmitting, by the processing device comprising the target, an End of Interrupt packet to acknowledge completion of the servicing of the interrupt request.

14. The method as recited in claim 13, comprising broadcasting the End of Interrupt packet on the plurality of point-to-point links to each of the plurality of devices.

15. The method as recited in claim 1, wherein the act of determining if the processing device is the target comprises the act of decoding the interrupt broadcast packet to determine a class of interrupt and an interrupt destination.

16. A method for implementing interrupt requests in a computing system comprising a first device and a plurality of processing devices interconnected by a plurality of point-to-point links, the method comprising the acts of:
generating, at the first device, a first communication comprising an interrupt request;
broadcasting the first communication on the plurality of point-to-point links to the plurality of processing devices;
decoding the first communication by each of the plurality of processing devices; and
determining by each of the plurality of processing devices, based on the decoding, whether to service the interrupt request.

17. The method as recited in claim 16, comprising the acts of:
servicing the interrupt request; and
transmitting an end-of interrupt message to indicate completion of servicing of the interrupt request.

18. The method as recited in claim 17, wherein the act of transmitting the end-of-interrupt message comprises broadcasting the end-of-interrupt message on the plurality of point-to-point links.

19. The method as recited in claim 16, comprising the act of:
transmitting, by each of the plurality of processing devices, a second communication to the first device in response to the first communication.

20. The method as recited in claim 19, wherein the second communication comprises priority data associated with the respective other device, and the method comprises:
selecting at the first device, based on the priority data, a target device of the plurality of processing devices to service the interrupt request;
generating a third communication identifying the target device; and
broadcasting the third communication on the plurality of point-to-point links to the plurality of processing devices.

21. The method as recited in claim 20, comprising the act of:
transmitting, by each of the plurality of processing devices, a fourth communication to the first device in response to the third communication.

22. The method as recited in claim 20, comprising the act of:
transmitting, by the target device, an end-of-interrupt message to indicate completion of servicing of the interrupt request.

23. The method as recited in claim 22, wherein the act of transmitting the end-of-interrupt message comprises broadcasting the end-of-interrupt message on the plurality of point-to-point links to each of the plurality of processing devices.

24. A computing system, comprising:
a communication link comprising a plurality of point-to-point links; and
a plurality of devices configured to communicate on the communication link,
wherein each of the point-to-point links interconnects a respective two devices of the plurality of devices,
wherein the plurality of devices comprises a plurality of processing devices, each of the plurality of processing devices comprising a processor,
wherein a first device of the plurality of devices is configured to broadcast a first interrupt request to the plurality of processing devices, and
wherein each of the plurality of processing devices is configured to determine whether to deliver the first interrupt request to its processor for servicing.

25. The system as recited in claim 24, wherein each of the plurality of processing devices is configured to generate a response to the first interrupt request and to transmit the response to the first device.

26. The system as recited in claim 25, wherein the response includes priority data corresponding to the processor associated with the processing device, and wherein the first device is configured to select a target processor to service the first interrupt request based on the priority data.

27. The system as recited in claim 24, wherein each of the plurality of processing devices is configured to generate an end-of-interrupt message to indicate completion of servicing of the first interrupt request by the processor associated with the processing device.

28. The system as recited in claim 26, wherein each of the plurality of processing devices is configured to broadcast the end-of-interrupt message on the plurality of point-to-point links.

29. The system as recited in claim 24, wherein the plurality of devices comprises a plurality of input/output (I/O) devices, and wherein the first device comprises a bridge connecting the plurality of I/O devices to the plurality of processing devices.

30. The system as recited in claim 29, wherein each of the plurality of I/O devices is configured to generate a second interrupt request and to transmit the second interrupt request to the first device, and wherein the first device is configured to translate the second interrupt request into the first interrupt request.

31. The system as recited in claim 24, wherein the first device comprises a processing device.
